(19) United States
(12) Patent Application Publication
(10) Pub. No.: US 2018/0297825 A1
(43) Pub. Date: Oct. 18, 2018

(54) OPERATING MACHINE BOOM

(71) Applicant: TADANO LTD., Kagawa (JP)

(72) Inventors: Kazuhiro KOBAYASHI, Kagawa (JP); Hiroshi TAKASHIMA, Kagawa (JP)

(73) Assignee: TADANO LTD., Kagawa (JP)

(21) Appl. No.: 15/766,893

(22) PCT Filed: Oct. 5, 2016
(86) PCT No.: PCT/JP2016/079582

§ 371 Date: Apr. 9, 2018

(30) Foreign Application Priority Data
Oct. 13, 2015 (JP) 2015-202220

(51) Int. Cl. B66C 23/70; B66F 9/12; B66F 9/075

(52) U.S. Cl. CPC B66C 23/702; B66F 9/07572; B66F 9/122; B66C 23/705

(57) ABSTRACT

The operating machine boom is an operating machine boom 40 including a tubular boom member 41 configured such that an upper member 42 and a lower member 43 with U-shaped sections are welded together with each upper flat portion 42a butting with a corresponding one of lower flat portions 43a. A welded portion 41b between the upper member 42 and the lower member 43 is on a compression portion B side with respect to a stress neutral point P at a boundary between a compression portion B at which compression stress is caused and a tension portion A at which tensile stress is caused when a load acts downwardly on a tip end side of the boom member 41, and a reinforcement member 44 is arranged on an inner surface side of the welded portion 41 b.

### TECHNICAL FIELD

The present invention relates to an operating machine boom applied to an operating machine including a boom, such as a crane device.

### BACKGROUND ART

Typically, an operating machine boom including a tubular boom member provided with flat portions on both sides in a width direction has been known as the operating machine boom of this type (see, e.g., Patent Literature 1).

In the operating machine boom, the thickness of a steel plate forming the boom member is decreased for weight reduction.

### CITATION LIST

### Patent Literature

### Patent Literature 1: JP 2003-312996 A

### SUMMARY OF THE INVENTION

### Problems to be Solved by the Invention

In the above-described operating machine boom, the thickness of the steel plate forming the boom member is decreased for weight reduction. However, stiffness is lowered, and for this reason, the flat portions easily buckle in a case where a load acts on the boom member.

An object of the present invention is to provide an operating machine boom configured so that the thickness of a steel plate forming a boom member can be decreased and buckling of the boom member can be reduced.

### Solutions to Problems

An operating machine boom according to one aspect of the present invention is an operating machine boom including a tubular boom member configured such that an upper member having an upper plate portion and a pair of upper flat portions extending downwardly from both sides of the upper plate portion in a width direction and having a U-shaped section and a lower member having a lower plate portion and a pair of lower flat portions extending upwardly from both sides of the lower plate portion in the width direction and having a U-shaped section are welded together with each upper flat portion butting with a corresponding one of the lower flat portions.

A welded portion between the upper member and the lower member is on a compression portion side with respect to a stress neutral point at a boundary between a compression portion at which compression stress is caused and a tension portion at which tensile stress is caused when a load acts downwardly on a tip end side of the boom member.

A reinforcement member is arranged on an inner surface side of the welded portion.

With this configuration, an easily-buckling portion of each flat portion of the boom member is reinforced by the reinforcement member, and therefore, buckling strength of the boom member is improved.

### Effects of the Invention

According to the present invention, the buckling strength of the boom member can be improved by the reinforcement member arranged as backing metal on the welded portion. Thus, the thickness of a steel plate forming the boom member can be decreased, and the weight of the boom member can be reduced.

### BRIEF DESCRIPTION OF DRAWINGS

FIG. 1 is a side view of a mobile crane according to one embodiment of the present invention.

FIG. 2 is a side view of a boom member.

FIG. 3 is a front sectional view of the boom member.

FIG. 4 is a side view of an extended state of a telescopic boom.

### DESCRIPTION OF EMBODIMENTS

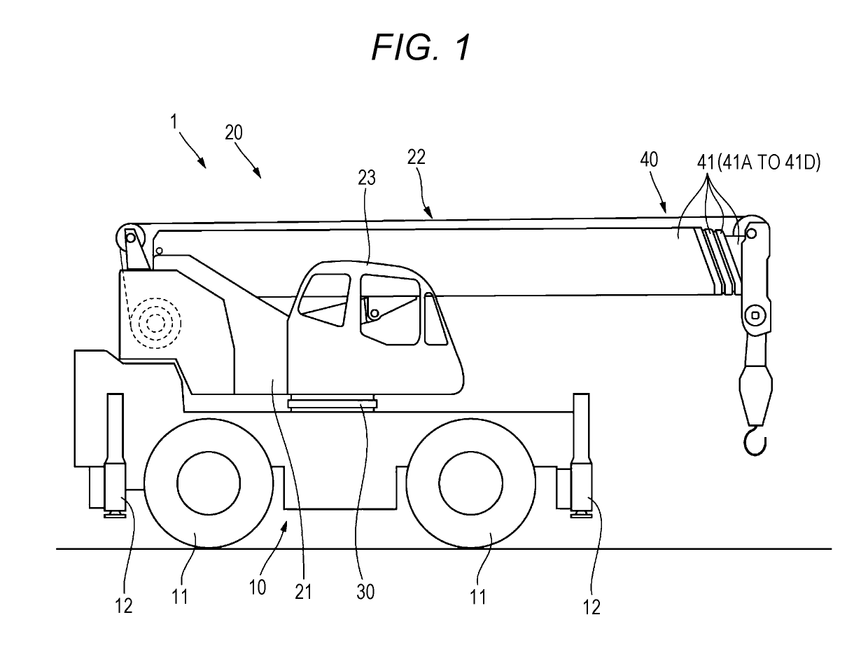

FIGS. 1 to 4 illustrate one embodiment of the present invention.

A mobile crane 1 including an operating machine boom of the present invention includes, as illustrated in FIG. 1, a base carrier 10 for traveling on a general road or in a working area, and an upper rotor 20 provided to rotate in the horizontal direction on the base carrier 10.

The base carrier 10 includes wheels 11 provided on both sides in a width direction at the front and back of a carrier frame extending in a front-to-back direction, and outriggers 12 provided on both sides in the width direction at front and back end portions of the carrier frame.

The upper rotor 20 includes a rotation base 21 coupled to the base carrier 10 through a rotation circle 30, a crane device 22 as an operating device provided one side of the rotation base 21 in the width direction, and a carburetor 23 provided on the other side of the rotation base 21 in the width direction and configured for travelling of the base carrier 10 and operation of the crane device 22.

The crane device 22 includes a telescopic boom 40 derrickably provided on the rotation base 21.

The telescopic boom 40 has multiple tubular boom members 411 to 414 (a tip end boom member 411, a first intermediate boom member 412, a second intermediate boom member 413, and a base end boom member 414). The telescopic boom 40 has a nesting structure of the boom members 411 to 414. In each of the intermediate boom members 412, 413 and the base end boom member 414 other than the extreme tip end side, a tip-end-side adjacent one of the tip end boom member 411 and the intermediate boom members 412, 413 is movably housed. The telescopic boom 40 has a telescopic cylinder and a derricking cylinder to be driven by operating oil discharged from a hydraulic oil, and telescopic operation and derricking operation of the boom members 411 to 414 are performed by these cylinders. In a case where the boom members 411 to 414 are not distinguished from each other, these members will be referred to as “boom members 41” in description below.

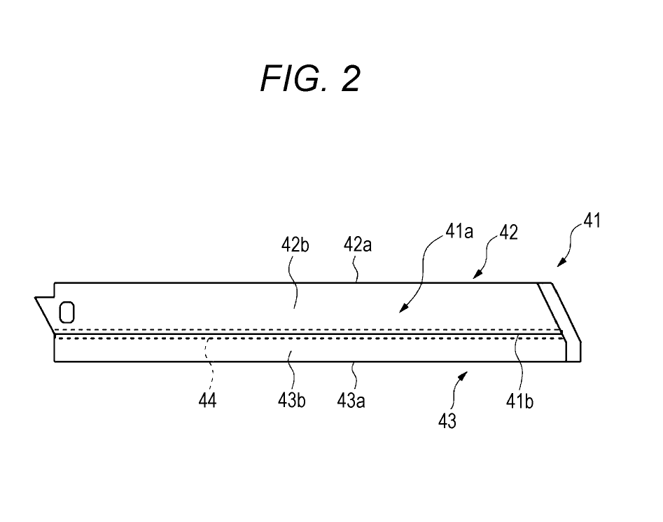

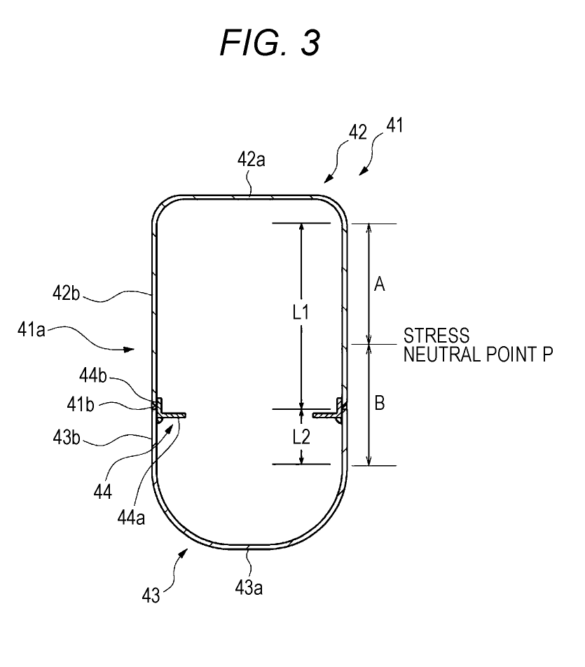

As illustrated in FIGS. 2 and 3, each boom member 41 has a rectangular sectional shape with curved corner portions, and is provided with a flat portion 41a extending in an upper-to-lower direction on each side in the width direction. Moreover, each boom member 41 has an upper member 42 forming an upper side of the boom member 41, a lower member 43 forming a lower side of the boom member 41, and a reinforcement member 44 configured to reinforce a lower side of each flat portion 41a of the boom member 41.

The upper member 42 is formed to have a U-shaped section in such a manner that an elongated steel plate (e.g., a high-tensile steel plate) is bent along a length direction. The upper member 42 has an upper plate portion 42a forming an upper portion of the boom member 41, and a pair of upper flat portions 42b extending downwardly from both end portions of the upper plate portion 42a in the width direction.

As in the upper member 42, the lower member 43 is formed to have a U-shaped section in such a manner that an elongated steel plate is bent along the length direction. The lower member 43 has a lower plate portion 43a forming a lower portion of the boom member 41, and a pair of lower flat portions 43b extending upwardly from both end portions of the lower plate portion 43a in the width direction. The lower plate portion 43a has an R-shape exhibiting excellent buckling resistance.

Note that the thicknesses of the upper member 42 and the lower member 43 are, as necessary, set to satisfy required buckling strength. The thickness of the lower member 43 may be the same as that of the upper member 42, or may be greater than that of the upper member 42. The upper member 42 and the lower member 43 are formed such that inner surfaces thereof are flush with each other when the upper flat portions 42b and the lower flat portions 43b butt with each other.

The upper member 42 and the lower member 43 are joined together by welding with the upper flat portions 42b and the lower flat portions 43b butting with each other. Each flat portion 41a includes the upper flat portion 42b of the upper member 42 and the lower flat portion 43b of the lower member 43. The reinforcement member 44 is arranged on an inner surface of each joint portion (each welded portion) 41b between the upper member 42 and the lower member 43.

The reinforcement member 44 is formed of a member extending from a base end side to a tip end side of the boom member 41 and having an L-shaped section, such as an L-type angle, and is fixed to an inner surface of the lower flat portion 43b of the lower member 43 by welding. The reinforcement member 44 has a stiffening portion 44a extending inwardly from an inner surface of the flat portion 41a in the width direction, and a backing portion 44b extending upwardly from a base end portion of the stiffening portion 44a.

The stiffening portion 44a functions as a stiffener configured to prevent buckling of a wall surface of the flat portion 41a. The dimension of extension of the stiffening portion 44a from the inner surface of the flat portion 41a is increased so that stiffness of the boom member 41 can be enhanced. The dimension of extension of the stiffening portion 44a is set considering fitting with members arranged inside, such as other boom members 41 and the telescopic cylinder.

The backing portion 44b is attached to an inner surface side of the welded portion 41b between a lower end of the upper flat portion 42b of the upper member 42 and an upper end of the lower flat portion 43b of the lower member 43. The backing portion 44b functions as backing metal configured to prevent blow-by in the process of joining, by welding, the lower end of the upper flat portion 42b and the upper end of the lower flat portion 43b and welded together with the upper member 42 and the lower member 43.

The height dimension L1 of the upper flat portion 42b as described herein is substantially three times as large as the height dimension L2 of the lower flat portion 43b. That is, the welded portion 41b is at a height position with a distance corresponding to a quarter of the height dimension L1+L2 of the flat portion 41a downwardly from a center portion of the flat portion 41a in the upper-to-lower direction.

In the telescopic boom 40 configured as described above, when a suspension load is suspended from a tip end of the tip end boom member 411, a load acts on each boom member 41 in the direction of downwardly displaying the tip end side. At this point, shear stress acts on the base end side of the boom member 41 protruding from a base-end-side adjacent one of the boom members 41. The shear stress acts on the tip end side of the boom member 41 housed in a base-end-side adjacent one of the boom members 41. That is, the shear stress acts on a portion 411a of the tip end boom member 411 housed in the first intermediate boom member 412, a portion 412a of the first intermediate boom member 412 housed in the second intermediate boom member 413, a portion 412b of the first intermediate boom member 412 housing the tip end boom member 411, a portion 413a of the second intermediate boom member 413 housed in the base end boom member 414, a portion 413b of the second intermediate boom member 413 housing the first intermediate boom member 412, and a portion 414b of the base end boom member 414 housing the second intermediate boom member 413. Further, bending stress acts on each boom member 41 across the entire area thereof.

At each flat portion 41a of the boom members 41 on which the shear stress and the bending stress act, tensile stress acts on the upper side in the upper-to-lower direction (a tension portion A), and compression stress acts on the lower side in the upper-to-lower direction (a compression portion B). A point P at which no stress is caused at a boundary between the tension portion A and the compression portion B will be referred to as a “stress neutral point.” When the length of the tension portion A is La and the length of the compression portion B is Lb, if the thickness is the same between the upper member 42 and the lower member 43, La=Lb is satisfied. That is, a center point of the flat portion 41a (the tension portion A+the compression portion B) in a height direction is the stress neutral point P.

At each flat portion 41a of the boom members 41, the lower side (the compression portion B) becomes an easily-buckling portion due to the suspension load. However, the lower side (the compression portion B) of the flat portion 41a is reinforced by the reinforcement member 44, and therefore, buckling due to action of the compression stress is reduced.

When the welded portion 41b between the upper member 42 and the lower member 43 is positioned at the tension portion A or the compression portion B, there is a probability that fatigue strength is lowered due to stress concentration. For this reason, the welded portion 41b is provided in the vicinity of the stress neutral point P (see, e.g., paragraphs [0002] and [0003] of JP 2008-87886 A).

On the other hand, for allowing the reinforcement member 44 serving as the backing metal to function as the stiffener configured to prevent buckling of the wall surface of the flat portion 41a, the upper member 42 and the lower member 43 are, in the present embodiment, designed such that the welded portion 41b between the upper member 42 and the lower member 43 is positioned at the compression portion B. In this case, lowering of the fatigue strength due to stress concentration on the welded portion 41b is concerned, but finishing of a weld toe is optimized so that stress concentration on the welded portion 41b can be alleviated. As compared to a case where backing metal and a stiffener are prepared and arranged as separate members, weight reduction can be realized, and the number of assembly processes can be reduced because of a smaller number of components.

The position (the arrangement position of the reinforcement member 44) of the welded portion 41b in the height direction as described herein is preferably such a position that the ratio L1/L2 of the length L1 of the upper flat portions 42b to the length L2 of the lower flat portions 43b is 3 to 4. With this configuration, the function of the reinforcement member 44 as the stiffener is effectively fulfilled, and therefore, buckling resistance of the flat portion 41a can be improved. In a case where the flat portion 41a bows in a transverse direction (the direction perpendicular to the flat portion 41a), the vicinity of the stress neutral point P shows a curved shape, whereas a flat shape is easily maintained in the vicinity of the position with a L1/L2 of 3 to 4. Thus, the above-described position is suitable as an arrangement portion of the reinforcement member 44.

As described above, according to the operating machine boom 40 of the present invention, in a case where the load downwardly acts on the tip end side of the boom member 41, the welded portion 41b between the upper member 42 and the lower member 43 is on a compression portion B side with respect to the stress neutral point Pas the boundary between the compression portion B at which the compression stress is caused and the tension portion A at which the tensile stress is caused, and the reinforcement member 44 is arranged on the inner surface side of the welded portion 41b.

With this configuration, the buckling strength of the boom member 41 can be improved, and therefore, the thickness of the steel plate forming the boom member 41 can be decreased. Consequently, the weight of the boom member 41 can be reduced. The reinforcement member 44 (specifically, the stiffening portion 44a) is designed as necessary so that stress concentration on the welded portion 41b can be alleviated and required buckling strength can be easily realized.

Moreover, the reinforcement member 44 is provided from a base end portion to a tip end portion of the boom member 41.

With this configuration, the reinforcement member 44 is arranged across the entire length of the boom member 41. Thus, even in a case where the bending stress acts on the boom member 41, buckling of the flat portion 41a can be reduced.

Further, the reinforcement member 44 has the backing portion 44b configured to prevent blow-by when the lower and upper ends of the upper and lower flat portions 42b, 43b in a pair are joined by welding.

With this configuration, both of reinforcement of the boom member 41 and blow-by prevention upon joining of the upper member 42 and the lower member 43 by welding can be realized by a single member, and therefore, the number of processes and a manufacturing cost can be reduced.

In addition, the stiffening portion 44a of the reinforcement member 44 extends from the inner surface of the flat portion 41a toward the center portion of the boom member 41 in the width direction.

With this configuration, the dimension of extension of the stiffening portion 44a is increased so that the stiffness of the boom member 41 can be enhanced. This can reliably reduce buckling of the flat portion 41a.

Note that in the above-described embodiment, the mobile crane has been described as the operating machine including the boom. However, the present invention is applicable to operating machines such as a high-place operating vehicle as long as these operating machines include booms.

Moreover, the above-described embodiment has described that the present invention is applied to the telescopic boom 40 of the crane device 22 configured such that when the load acts on the boom member 41, the tensile stress acts on the upper side of the flat portion 41a and the compression stress acts on the lower side of the flat portion 41a, but the present invention is not limited to above. For example, in a case where the present invention is applied to a boom of a drilling and pole-erecting vehicle, when a load acts on a boom member, compression stress acts on an upper side of a flat portion, and tensile stress acts on a lower side of the flat portion.

Further, the above-described embodiment has described that the present invention is applied to the telescopic boom 40 having the multiple boom members 41, but the present invention is not limited to above. The present invention is also applicable to even a boom including a single boom member.

In addition, the above-described embodiment has described that the welded portion 41b is at the height position with the distance corresponding to the quarter of the height dimension of the flat portion 41a downwardly from the center portion of the flat portion 41a in the upper-to-lower direction and that the reinforcement member 44 is fixed to the inner side of the welded portion 41b in the width direction, but the present invention is not limited to above. For example, in a case where the lower member 43 is formed of a steel plate having a greater thickness than that of the upper member 42, the area (the tension portion A) of the flat portion 41a on which the tensile stress acts becomes larger, and the area (the compression portion B) of the flat portion 41a on which the compression stress acts becomes smaller. Accordingly, the positions of the welded portion 41b and the reinforcement member 44 may be set.

Moreover, the above-described embodiment has described that the member with the L-shaped section is used as the reinforcement member 44, but the present invention is not limited to above. Square steel, a square steel pipe, channel steel, etc. may be used as the reinforcement member as long as the reinforcement member has a flat surface configured to prevent blow-by upon welding. For example, the reinforcement member 44 may be formed such that the stiffening portion 44a protrudes in a T-shape from the backing portion 44b. Alternatively, the thickness of the backing portion 44b is increased so that the reinforcement member 44 can function as the stiffener.

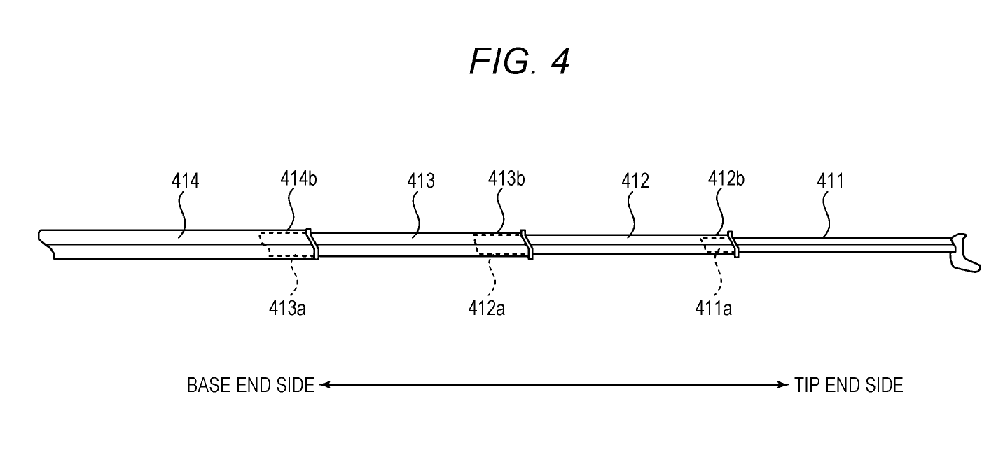

Further, in the reinforcement member 44, the backing portion 44b may be arranged across the entire length of the boom member 41, and the stiffening portion 44a may be locally provided in the length direction of the boom member 41. For example, stress tends to concentrate on a portion of the boom member 41 overlapping with the adjacent boom member 41 (see FIG. 4), and therefore, the stiffening portion 44a may be provided only at such a portion. As described above, the reinforcement member 44 is, including the shape and dimensions of the reinforcement member 44 and the arrangement form of the stiffening portion 44a, designed as necessary so that a flexible response according to required buckling strength can be ensured.

### REFERENCE SIGNS LIST

40 telescopic boom
41 boom member
41a flat portion
41b joint portion
42 upper member
42a upper plate portion
42b upper flat portion
43 lower member
43a lower plate portion
43b lower flat portion
44 reinforcement member
44a stiffening portion
44b backing portion

1. An operating machine boom comprising:
a tubular boom member configured such that an upper member having an upper plate portion and a pair of upper flat portions extending downwardly from both sides of the upper plate portion in a width direction and having a U-shaped section and a lower member having a lower plate portion and a pair of lower flat portions extending upwardly from both sides of the lower plate portion in the width direction and having a U-shaped section are welded together with each upper flat portion butting with a corresponding one of the lower flat portions,
wherein a welded portion between the upper member and the lower member is on a compression portion side with respect to a stress neutral point at a boundary between a compression portion at which compression stress is caused and a tension portion at which tensile stress is caused when a load acts downwardly on a tip end side of the boom member,
a reinforcement member is arranged on an inner surface side of the welded portion, and
the reinforcement member includes a backing portion contacting the welded portion, and a stiffening portion protruding inwardly from the backing portion.

2. The operating machine boom according to claim 1, wherein
the welded portion is arranged at such a position that a ratio L1/L2 of a length L1 of each upper flat portion to a length L2 of a corresponding one of the lower flat portions is 3 to 4.

3. (canceled)

4. The operating machine boom according to claim 1, wherein
the reinforcement member has such an L-shaped section that the stiffening portion is bent and extends from an end portion of the backing portion in an upper-to-lower direction.

5. The operating machine boom according to claim 1, wherein
the backing portion and the stiffening portion are provided across an entire length of the boom member.

6. The operating machine boom according to claim 1, wherein
the backing portion is provided across an entire length of the boom member, and
the stiffening portion is locally provided in a length direction of the boom member.

7. The operating machine boom according to claim 1, wherein
each upper flat portion butts with a corresponding one of the lower flat portions such that inner surfaces thereof form a flat surface, and
the reinforcement member is arranged on the inner surface side of the welded portion such that the backing portion extends over the each upper flat portion and the corresponding one of the lower flat portions.
